(19) United States
(12) Patent Application Publication
(10) Pub. No.: US 2006/0107609 A1
(43) Pub. Date: May 25, 2006

(54) Cover for a fastener

(76) Inventors: Erin S. Stringer, Powell, OH (US); Anthony Ordonio JR., Dublin, OH (US); Shawn L. Tarr, Dublin, OH (US)

Correspondence Address: MICHAEL A. FORHAN;ELEY LAW FIRM CO., SUITE 311, 7870 OLENTANGY RIVER RD., COLUMBUS, OH, 43235, US

(21) Appl. No.: 11/272,280

(22) Filed: Nov. 11, 2005

Related U.S. Application Data
(60) Provisional application No. 60/627,067, filed on Nov. 12, 2004.

(51) Int. Cl. B44F 7/00; B44F 9/00; E04C 1/00

(52) U.S. Cl. 52/312

(57) ABSTRACT

A garnish system for a vehicle. The system comprises a garnish having a patterned surface with styling features, a cavity, and a mounting aperture within the cavity for receiving a fastener to attach the garnish to a mounting structure. A cover is shaped to engage and close the cavity such that the cover, which is patterned to correspond to the styling features of the garnish, visually obscures the cover when the cover is installed. A method employs the cover.

This application claims priority to U.S. provisional application 60/627,067, filed Nov. 12, 2004, the contents of which are hereby incorporated by reference.

### FIELD

The present invention relates generally to fasteners for attaching garnishes to a vehicle, particularly to fastener covers that blend in with surrounding styling features of the garnish and aid to disguise the fastener.

### BACKGROUND

Garnishes are used in the automotive industry for various purposes such as enhancing the styling of vehicles, providing protection for surfaces and edges of components, and covering openings or gaps. The garnishes are typically attached to a mounting structure of a vehicle with one or more recessed fasteners such as screws. The screws are often covered by a snap-in cap to protect them from the elements and provide a more finished appearance for the garnish. However, such caps, which are typically round in shape and extend above the surface of the garnish, have a shortcoming in that they interrupt the visual pattern of the garnish. The caps thus detract from the esthetics of the garnish.

Some garnishes may be attached to a mounting structure with push-in fasteners instead of screws. One known push-in type fastener for attaching garnishes, commonly referred to as a “fir tree” fastener, includes a shaft portion with fins or ridges that extends through the garnish and engages a mounting aperture of a mounting structure. The push-in fastener further includes a head portion that engages an outer surface of the garnish to hold the garnish in place. The head of the push-in fastener is visible after installation and likewise generally detracts from the esthetics of the garnish. Push-in fasteners are also frequently exposed to the elements, causing them to degrade and become difficult to remove without damage to the fasteners and/or garnish.

Yet another way of attaching a garnish to a vehicle involves assembling together a fastener element and a retainer element. The retainer, such as a keyhole-shaped mounting aperture, is located on a concealable surface of the garnish. The fastener, such as a headed pin, is attached to a mounting structure. The garnish is attached to the vehicle by inserting the head of the pin into a rounded portion of the keyhole, then moving the garnish laterally with respect to the pin such that a shaft portion of the pin travels to a slot portion of the keyhole, securing the garnish in place. While such fastening assemblies are hidden and protected after the garnish is installed, the retainer and fastener can be difficult to align for assembly since the installer often cannot see the retainer and fastener when the garnish is placed into position for assembly. Additionally, the retainer and fastener can be difficult to disengage without damage should the garnish need to be removed.

There is a need for a way to conceal and protect fasteners for garnishes that provides convenient access to the fastener for installation and removal of the garnish, reduces the potential for damage to the garnish upon removal, and does not detract from the esthetics of the garnish.

### SUMMARY

The present invention provides a novel fastener cover that is patterned to visually blend with surrounding styling features of a garnish. The cover interfaces with the garnish such that the gap between the cover and the garnish is oriented generally parallel to the surface of the garnish, concealing the fastener from view without detracting from the esthetics of the garnish.

An aspect of the invention is a garnish system for a vehicle. The system comprises a garnish having a patterned surface with styling features, a cavity, and a mounting aperture within the cavity for receiving a fastener to attach the garnish to a mounting structure. A cover is shaped to engage and close the cavity such that the cover, which is patterned to correspond to the styling features of the garnish, visually obscures the cover when the cover is installed.

Another aspect of the invention is a garnish system for a vehicle. The system comprises a garnish having a patterned surface with styling features, a cavity, and a mounting aperture within the cavity for receiving a fastener to attach the garnish to a mounting structure. A cover is shaped to engage and close the cavity. The cover includes a grooved portion that engages a tongued portion of the garnish to attach the cover to the garnish. The cover is patterned to correspond to the styling features of the garnish to visually obscure the cover when the cover is installed.

Still another aspect of the invention is a method for attaching a garnish to a mounting structure. The method comprises the steps of constructing a pattern of styling features on a surface of the garnish, forming a cavity in the garnish, and installing a mounting aperture in the cavity. Additional steps include locating the mounting aperture proximate the mounting structure, installing a fastener into both the mounting aperture and the mounting structure to attach the garnish to the mounting structure, and closing the cavity with a cover such that the cover is patterned to correspond to the styling features of the garnish to visually obscure the cover.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a perspective view of a garnish, a fastener and a cover for the fastener according to an embodiment of the present invention;

FIG. 2 is a view in section of the garnish, fastener and cover of FIG. 1;

FIG. 3 is a perspective view of a garnish, a fastener and a cover for the fastener according to another embodiment of the present invention;

FIG. 4 is a view in section of the garnish, fastener and cover of FIG. 3;

FIG. 5 is a top plan view of a garnish and fastener cover according to yet another embodiment of the present invention;

FIG. 6 is a top plan view of a garnish and a fastener according to still another embodiment of the present invention;

FIG. 7 is a view in section of a garnish and cover according to yet another embodiment of the present invention; and

FIG. 8 is a perspective view of a garnish and a hinged fastener cover according to still another embodiment of the present invention.

### DETAILED DESCRIPTION

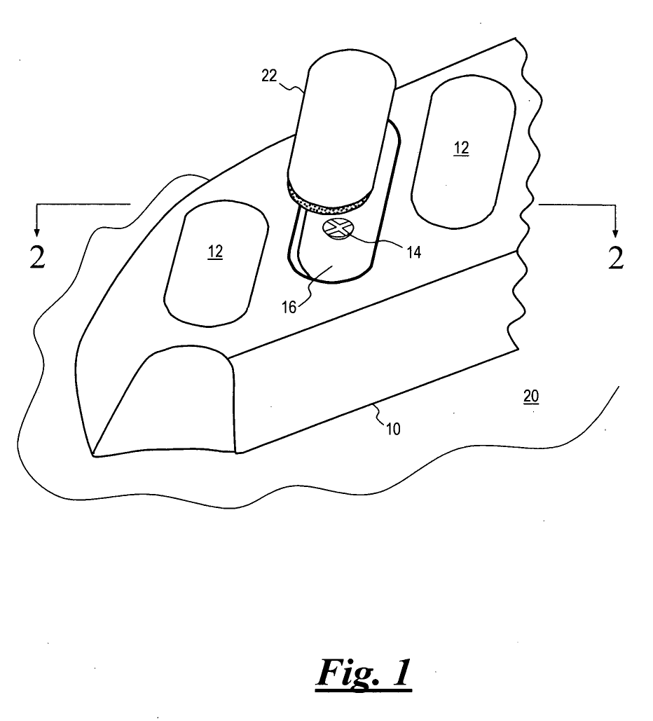

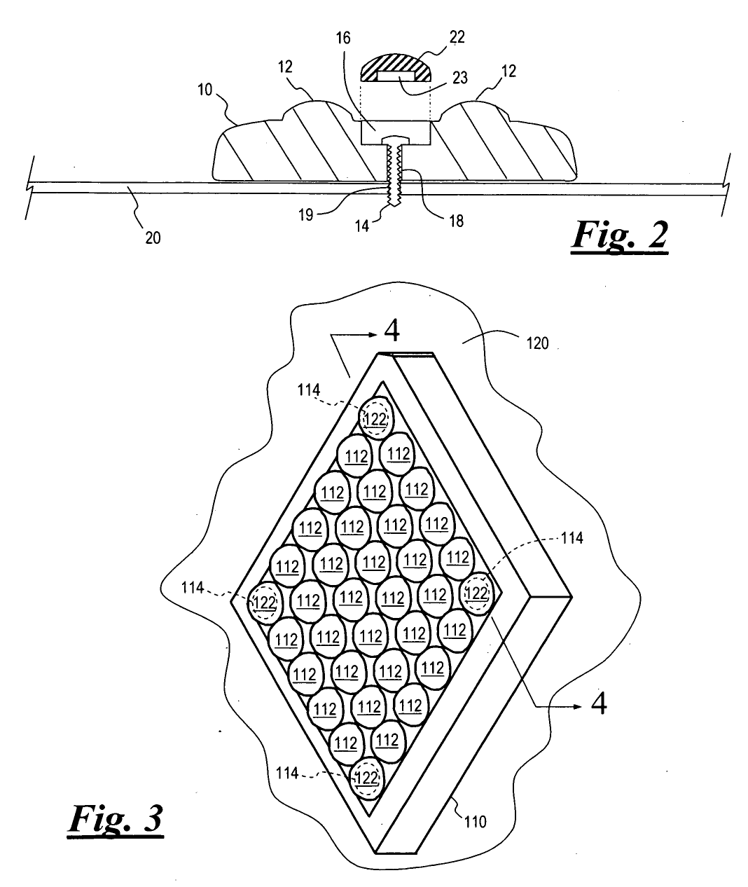

A cover for a fastener according to an embodiment of the present invention is shown in FIGS. 1 and 2. A piece of trim or garnish 10 includes a patterned surface having styling features, such as a plurality of oblong-shaped, raised styling features 12. A fastener 14, such as a screw or a “fir tree” push-in fastener, is installed into a cavity 16 of garnish 10 and then inserted through a mounting aperture 18 of the garnish to secure it to an adjacent mounting aperture 19 of a mounting structure 20, such as an exterior or interior portion of a vehicle. Mounting aperture 19 may be threaded to receive a screw-type fastener 14, or sized to retain fins or ridges of a push-in fastener. Alternately, fastener 14 may be a self-tapping screw, in which case mounting aperture 19 need not be present. A cover 22 is shaped similarly to styling features 12 so as to visually blend in with the styling features and, accordingly, functions as a camouflaged cover. Cover 22 is further adapted to engage cavity 16 with an interference fit to retain the cover to garnish 10, and may optionally include a recessed portion 23 to provide additional clearance for fastener 14 when the cover is installed. The gap between the perimeter of cover 22 and the perimeter of cavity 16 is preferably minimal so that the cover, when attached to garnish 10, does not visually interrupt the pattern of styling features 12.

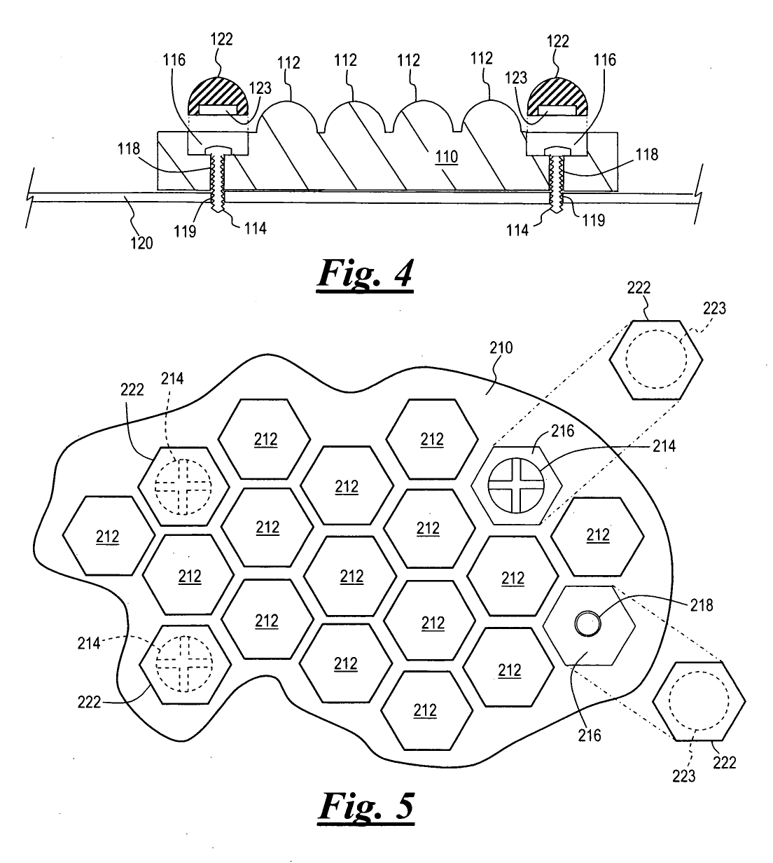

It should be noted that the present invention can be adapted to correspond with garnishes having various shapes and features. An example of a cover 122 adapted to correspond to a garnish 110 having generally dome-shaped styling features 112 is depicted in FIGS. 3 and 4. A fastener 114, such as a screw or push-in fastener, is installed into a cavity 116 of garnish 110 and through a mounting aperture 118 of the garnish to secure it to an adjacent mounting aperture 119 of a mounting structure 120, such as an exterior or interior portion of a vehicle. Alternately, fastener 114 may be a self-tapping screw, in which case mounting aperture 119 need not be present. Cover 122, which is shaped similarly to styling features 112 so as to visually blend in with the styling features, detachably engages cavity 116 with an interference fit to retain the cover to the garnish. Cover 122 may optionally include a recessed portion 123 to provide additional clearance for fastener 114 when the cover is installed. When in place, cover 122 hides fastener 114 and the cavity 116 from view without detracting from the esthetics of the garnish.

As previously indicated, the present invention may be used with garnishes having styling characteristics of any shape by forming one or more covers in at least one of a shape, color, and texture corresponding to the styling characteristics. A further example is shown in FIG. 5, wherein hexagonal-shaped covers 222 are shaped to correspond with surface pattern characteristics comprising hexagonal-shaped styling features 212 of a garnish 210 to cover fasteners 214. Fastener 214 is installed into a cavity 216, through a mounting aperture 218, and engages a mounting structure (not shown) in any manner previously discussed. As noted previously, cover 222 is preferably made of a shape, color, material and texture to as appropriate to closely correspond to the surrounding styling features of the garnish, and may include a recessed portion 223 to provide additional clearance for fastener 214 when the cover is installed. The garnish, styling features, fastener, cavity, cover, mounting apertures and mounting structure are otherwise similar in structure and function to the like-named components previously discussed and so will not be restated here.

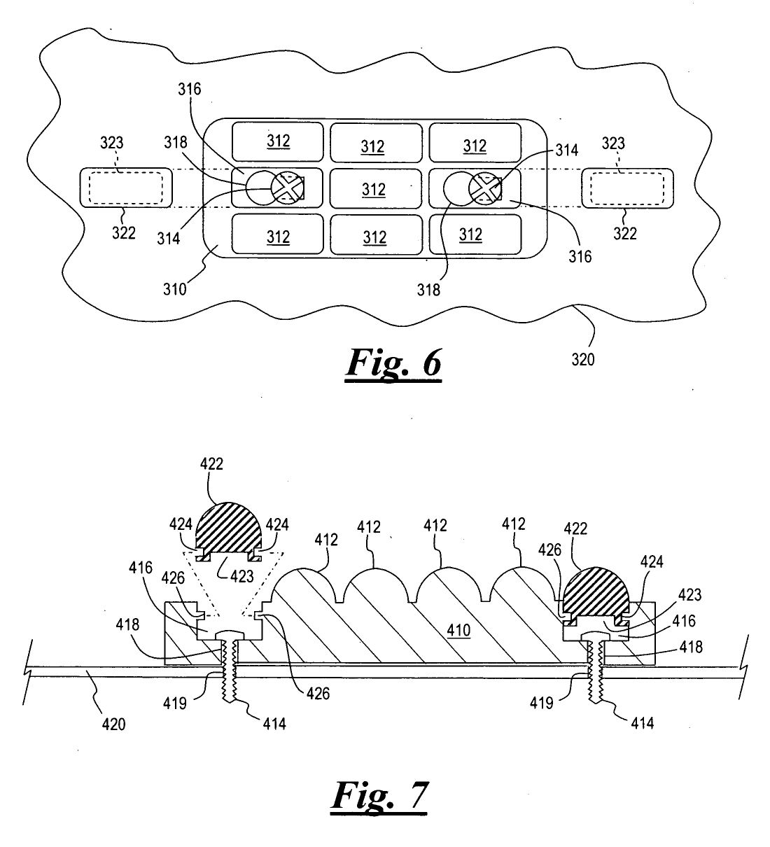

With reference to FIG. 6, in still another embodiment of the present invention a garnish 310 may have at least one cavity 316 that further includes a “T”-shaped or keyhole-shaped mounting aperture 318. In this embodiment a headed fastener 314 is secured to a mounting structure 320. Garnish 310 is aligned over fastener 314 and the head of the fastener is inserted into a larger, rounded portion of mounting aperture 318 to engage the head. Garnish 310 is then moved laterally such that a shaft portion of fastener 314 moves into a smaller, slotted retaining portion of mounting aperture 318, securing the garnish to the mounting structure 320. A cover 322 having a shape, color and texture similar to styling features 312 is then installed, visually obscuring cavity 316. The cover 322 may optionally include a recessed portion 323 to provide additional clearance for fastener 314 when the cover is installed. The garnish, styling features, fastener, cavity, cover, mounting apertures and mounting structure are otherwise similar in structure and function to the like-named components previously discussed and so will not be restated here.

With reference now to FIGS. 1 through 5 in combination, the cover may be permanently or detachably attached to the garnish by use of any conventional attachment means including, without limitation, an interference-type press-fit or snap-fit between the cover and the garnish, adhesive, hook-and-loop, tabs, ribs, tongue and groove, threaded couplings and protrusions. In addition, although the embodiments shown in FIGS. 1 through 5 depict a cover engaging the perimeter of a cavity, one skilled in the art will recognize that the cover may alternatively be made with grooved or tabbed portions shaped to slidably engage an inner tongue or slot portion of the garnish to secure the cover to the garnish. An illustrative example is shown in FIG. 7 wherein the embodiment of FIG. 3 is modified to utilize covers 422 having one or more slots or grooves 424. Grooves 424 are shaped to slidably couple to one or more complementary tongues 426 formed in a garnish 410. Use of such grooves, tabs, slots, tongues and channels is well-known in the art, and details of same are left to the artisan. It is to be understood that the groove portions 424 and tongue portions 426 may be likewise incorporated with any of the embodiments of the present invention described herein. It is also to be understood that tongues 426 could be formed in cover 422 and grooves formed in garnish 410.

With continued reference to FIG. 7, a fastener 414, such as a screw or push-in fastener, is installed into a cavity 416 of garnish 410 and through a mounting aperture 418 of the garnish to secure it to an adjacent mounting aperture 419 of a mounting structure 420, such as an exterior or interior portion of a vehicle. Alternately, fastener 414 may be a self-tapping screw, in which case mounting aperture 419 need not be present. Cover 422 is preferably made of a shape, color, material and texture to as appropriate to closely correspond to the surrounding styling features 412 of the garnish, and may include a recessed portion 423 to provide additional clearance for fastener 414 when the cover is installed. The garnish, styling features, fastener, cavity, cover, mounting apertures and mounting structure are otherwise similar in structure and function to the like-named components previously discussed and so will not be restated here.

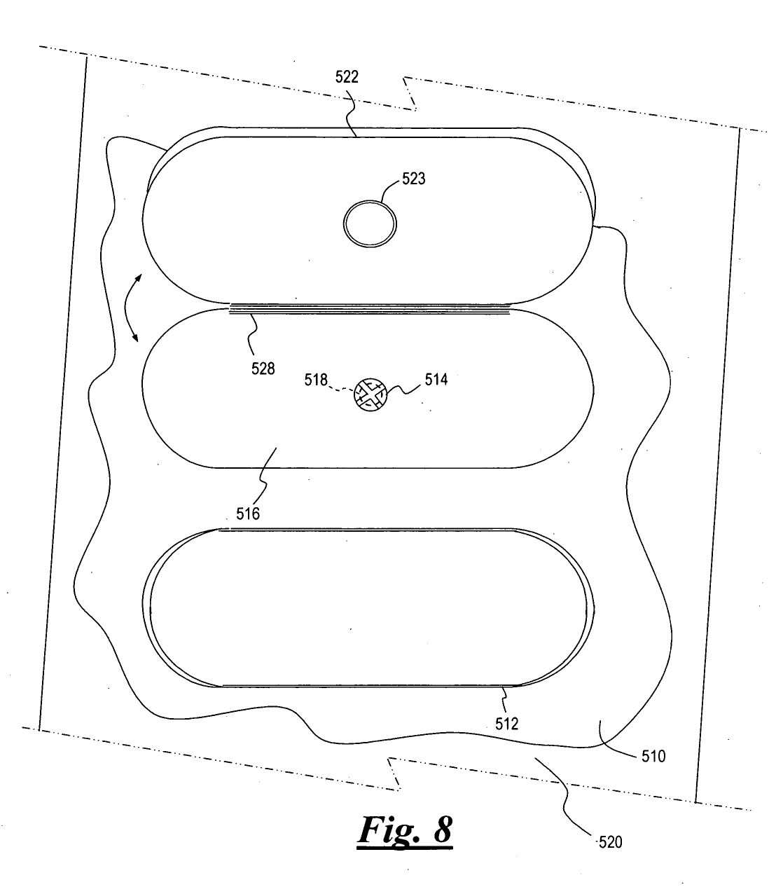

With reference to FIG. 8, in yet another embodiment of the present invention a cover 522 may be formed with a garnish 510 and pivotally attached to the garnish with a “living hinge” 528. In this embodiment cover 522 may be pivoted away from a cavity 516 to provide access to attach garnish 510 to a mounting structure 520 with a fastener 514. A fastener 514, such as a screw or push-in fastener, is installed into cavity 516 of garnish 510 and through a mounting aperture 518 of the garnish to secure it to an adjacent mounting structure 520 in any manner previously discussed.

After fastener 514 is secured, cover 522 is pivoted to a closed position, covering and visually obscuring the cavity 516. Cover 522 may be held in a closed position by any of the previously-discussed cover attachment devices including, without limitation, press-fit or snap-fit between the cover and the garnish, adhesive, hook-and-loop, tongue and groove, tabs, ribs, threaded couplings, and protrusions. Cover 522 is preferably made of a shape, color, material and texture to as appropriate to closely correspond to the surrounding styling features 512 of the garnish, and may include a recessed portion 523 to provide additional clearance for fastener 514 when the cover is installed. The garnish, styling features, fastener, cavity, mounting apertures and mounting structure are otherwise similar in structure and function to the like-named components previously discussed and so will not be restated here.

As can be seen, the present invention may be employed with garnishes having a wide variety of surface patterns and shapes. Furthermore, the number of styling characteristics may be greater or lesser without affecting the scope of the invention. For example, a garnish may have a fewer number of styling characteristics of a desired size, such as the oblong-shaped styling features 12 depicted in FIG. 1. Conversely, the garnish may have a number of closely-spaced styling characteristics, such as styling features 112, shown in FIG. 3, and 212, shown in FIG. 5.

In the aforementioned embodiments, in addition to its visual similarity to its surroundings, a cover according to the present invention may be made from a material similar to the material used for the garnish, or may be made from differing materials having greater or lesser elasticity for ease of installation and removal. In some embodiments it may be desirable to make the cover from a different material than the garnish and then coat the cover with the same or a similar material as the garnish. For example, a cover may be made of metal and then coated with a plastic material that is the same as, or similar to, the material of a plastic garnish. The cover may be finished to correspond to the finish, pattern, texture, and grain of the garnish so as to visually blend in with the garnish.

While this invention has been shown and described with respect to a detailed embodiment thereof, it will be understood by those skilled in the art that changes in form and detail thereof may be made without departing from the scope of the claims of the invention.

What is claimed is:

1. A garnish system for a vehicle, comprising:
a garnish having a patterned surface with styling features, a cavity, and a mounting aperture within the cavity for receiving a fastener to attach the garnish to a mounting structure; and
a cover shaped to engage and close the cavity,
wherein the cover is patterned to correspond to the styling features of the garnish to visually obscure the cover when the cover is therein installed.

2. The garnish system of claim 1 wherein the cover is detachable from the garnish.

3. The garnish system of claim 1 wherein the cover is hingedly attached to the garnish.

4. The garnish system of claim 1 wherein the pattern of the cover corresponds to at least one of the shape, material, texture and finish of the styling features of the garnish.

5. The garnish system of claim 1 wherein the patterned surface of the garnish comprises a plurality of oblong-shaped styling features.

6. The garnish system of claim 1 wherein the patterned surface of the garnish comprises a plurality of generally dome-shaped styling features.

7. The garnish system of claim 1 wherein the patterned surface of the garnish comprises a plurality of hexagonal-shaped styling features.

8. The garnish system of claim 1 wherein the cover is engaged to the garnish with at least one of a press-fit, a snap-fit, adhesive, hook-and-loop, tab, rib, tongue and groove, threaded coupling, and protrusion.

9. The garnish system of claim 1 wherein the fastener is one of a screw and a push-in fastener.

10. The garnish system of claim 1 wherein the cover further comprises a recessed portion.

11. The garnish system of claim 1 wherein:
the fastener is a headed pin attached to the mounting structure; and
the mounting aperture comprises a keyhole shape,
wherein the pin engages the mounting aperture to attach the garnish to the mounting structure.

12. A garnish system for a vehicle, comprising:
a garnish having a patterned surface with styling features, a cavity, and a mounting aperture within the cavity for receiving a fastener to attach the garnish to a mounting structure;
a cover shaped to engage and close the cavity; and
a grooved portion in the cover,
wherein the grooved portion engages a tongued portion of the garnish to attach the cover to the garnish, and
wherein the cover is patterned to correspond to the styling features of the garnish to visually obscure the cover when the cover is therein installed.

13. A garnish system for a vehicle, comprising:
a garnish having a patterned surface with styling features, a cavity, and a mounting aperture within the cavity through which a fastener engages a mounting structure to attach the garnish to the mounting structure; and
a detachable cover shaped to engage and close the cavity,
wherein the cover is patterned to correspond to the styling features of the garnish to visually obscure the cover when the cover is therein installed,
wherein the pattern of the cover visually corresponds to at least one of the shape, material, texture and finish of the patterned surface of the garnish, and
wherein the cover is attached to the garnish with at least one of a press-fit, a snap-fit, adhesive, hook-and-loop, tab, rib, tongue and groove, threaded coupling and protrusion.

14. A method for attaching a garnish to a mounting structure, comprising the steps of:
constructing a pattern of styling features on a surface of the garnish;
forming a cavity in the garnish;
installing a mounting aperture in the cavity;
locating the mounting aperture proximate the mounting structure;
installing a fastener into both the mounting aperture and the mounting structure to attach the garnish to the mounting structure; and
closing the cavity with a cover such that the cover is patterned to correspond to the styling features of the garnish to visually obscure the cover.

15. The method of claim 14, further comprising the step of making the cover detachable from the garnish.

16. The method of claim 14, further comprising the step of hingedly attaching the cover to the garnish.

17. The method of claim 14, further comprising the step of adapting the pattern of the cover to correspond to at least one of the shape, material, texture and finish of the styling features of the garnish.

18. The method of claim 14, further comprising the step of patterning the surface of the garnish with a plurality of oblong-shaped styling features.

19. The method of claim 14, further comprising the step of patterning the surface of the garnish with a plurality of generally dome-shaped styling features.

20. The method of claim 14, further comprising the step of patterning the surface of the garnish with a plurality of hexagonal-shaped styling features.

21. The method of claim 14, further comprising the step of attaching the cover to the garnish with at least one of a press-fit, a snap-fit, adhesive, hook-and-loop, tabs, ribs, tongue and groove, threaded couplings and protrusions.

22. The method of claim 14, further comprising the step of selecting one of a screw and a push-in fastener.

23. The method of claim 14, further comprising the step of forming a recessed portion in the cover.

24. A method for attaching a garnish to a mounting structure, comprising the steps of:
constructing a pattern of styling features on a surface of the garnish;
forming a cavity in the garnish;
forming a keyhole-shaped mounting aperture in the cavity;
installing a headed pin into the mounting structure;
locating the keyhole-shaped mounting aperture proximate the mounting structure;
engaging the keyhole-shaped mounting aperture to the headed pin to attach the garnish to the mounting structure; and
closing the cavity with a cover such that the cover is patterned to correspond to the styling features of the garnish to visually obscure the cover.

25. A method for attaching a garnish to a mounting structure, comprising the steps of:
constructing a pattern of styling features on a surface of the garnish;
forming a cavity in the garnish;
installing a mounting aperture in the cavity;
locating the mounting aperture proximate the mounting structure;
installing a fastener into both the mounting aperture and the mounting structure to attach the garnish to the mounting structure; and
closing the cavity with a detachable cover with at least one of a press-fit, a snap-fit, adhesive, hook-and-loop, tab, rib, tongue and groove, threaded coupling, and protrusion such that the cover is patterned to correspond to at least one of the shape, material, texture and finish of the styling features of the garnish to visually obscure the cover.
